(19) United States
(12) Patent Application Publication
(10) Pub. No.: US 2026/0115750 A1
(43) Pub. Date: Apr. 30, 2026

(54) SYSTEM, APPARATUS, AND PAINTING PROCESS OF A LINEAR NOTEBOOK MANUFACTURING PROCESS

(71) Applicant: CARVAJAL EDUCACIÓN S.A.S, VALLE DEL CAUCA, (CO)

(72) Inventors: Walter MONTENEGRO PRADEZ, Cali (CO); Pedro CUASMAYAN BOCANEGRA, Cali (CO); Boris GRANADA ZULETA, Cali (CO)

(21) Appl. No.: 19/372,899

(22) Filed: Oct. 29, 2025

(30) Foreign Application Priority Data
Oct. 29, 2024 (MX) MX/A/2024/013382

(51) Int. Cl. B05B 13/02; B05B 12/02

(52) U.S. Cl. CPC B05B 13/0221; B05B 12/02

(57) ABSTRACT

The present invention relates to a system, apparatus, and process related to the uniform painting of the three edges of a notebook or notepad o similar products, which is part of a linear production process. The system comprises a feeding module, a spraying module, a redirection module, and a second spraying module

### TECHNICAL FIELD OF THE INVENTION

The present invention relates to a system, apparatus, and process related to painting the edges of notebooks and/or notepads. In particular, the present invention focuses on a process for uniformly painting the three edges of a notebook or notepad, or similar products, which is part of a linear production process.

### BACKGROUND OF THE INVENTION

The importance of being able to distinguish a product such as a notebook is very relevant in various contexts, due to the information it contains or is intended to contain, so its easy recognition offers an advantage to the user in avoiding errors and confusion.

Within the state of the art, there are various ways and methods for identifying a notebook, book, or similar items. One of these is through indexing, and there are similar methods that involve printing identifiers on one of the edges using special and expensive equipment to print an identifier on one of the edges of the notebook, book, or similar items. Thus, the prior art document CN 208558653 discloses a color printing machine for printing an edge of a plurality of books (batch), which is used in the field of lithography devices and comprises a printing platform, a crossbar, a print head, and a clamping mechanism.

Therefore, this technique requires rearranging the multiple books on the platform to print each of their edges, as well as constant maintenance and adjustment of the print head. However, a simpler way to identify a notebook or notepad is by using a color on all of its edges, which avoids the need to place or position the notebook or notepad in a single orientation in order to identify it.

Document CN 215243713 U of the prior art discloses a manual device that allows ink to be sprayed onto the edges of a plurality of notebooks, wherein the plurality of notebooks remain fixed in the device and a spraying mechanism is moved manually to paint the edges of the plurality of notebooks.

Likewise, Mexican patents No. 341108 and No. 337261 are also part of the prior art, disclosing a process and an apparatus, respectively, both related to painting the edge of a product such as a notebook, or similar, in which the edges of the sheets are painted.

In particular, Mexican patent No. 337261 describes and protects a manual apparatus for preparing the edges of a plurality of notebooks for painting, in which the notebooks are stacked in four columns arranged in a circular area, and the spines of the notebooks are in contact with a central column, leaving the three edges of the pages of each notebook uncovered. This device can be configured for different notebook sizes and includes separator elements that allow height adjustment based on the shape of a stack of notebooks, given that a notebook has a higher elevation at the spine. Subsequently, these stacks of notebooks are held in place by a pressing mechanism in order to achieve a surface consisting exclusively of the thickness of the notebook pages. Finally, the painting process is carried out manually by a person on the three exposed edges of the four stacks held by the device.

Thus, the efficiency of this painting process depends on the skill of the person or persons involved in the process, from placing, arranging, and securing the notebooks using the elements of the device, as well as the skill of painting the edges of the multiple notebooks in the four stacks held by the device using a painting system to achieve uniform painting without overpainting the edges, given that the pages absorb the ink into the interior thereof.

On the other hand, Mexican patent No. 341108 discloses and protects a process for coating each of the edges of a notebook with ink by spraying ink, emphasizing the value of the viscosity of the ink, which allows the ink to come into contact with the edge of the notebook and only the amount of ink that coats the edge or thickness of each of the sheets to be absorbed, and prevents the ink from running into the interior of the notebook or notepad sheet. Thus, this process is limited to the viscosity of the ink; however, other factors that influence it, as mentioned in the technical report, are the environmental conditions and the type of paper used for the notebook sheets. Consequently, the uniformity and quality of the painting of the edges of the notebooks in the patented process will also depend on the skill of the person operating the pneumatic painting system used.

Consequently, there is a need for a system, apparatus, and process for painting the edges of a notebook or notepad that is effective and does not require excessive attention and time from personnel to place and arrange a plurality of notebooks in an apparatus for painting their edges, as well as to remove the plurality of notebooks from the apparatus once the edges have been painted.

In this regard, a system, apparatus, and process for painting the edges of a notebook or notepad is required that does not depend on the viscosity of the ink or paint used for its application, so that the full range of colors can be used.

This is why the system, apparatus, and process for painting the edges of a notebook or pad of the present invention solves the problem defined above in the prior art and also fits seamlessly into the production process of a final product, in this case a notebook or pad.

Thus, the present invention has several features that make it completely different from existing systems, devices, and processes because it does not require a manual device or the use of paints and inks with a specific viscosity. As will be seen later in this specification, the present invention has a particular configuration and sequence to achieve uniform painting on the three edges of each product or notebook.

Therefore, those with experience in the technique are aware of the need for a system, apparatus, and process such as that proposed by the present invention, which is comprehensive and efficient within a notebook and notepad production process. Thus, this technical report discloses a system, apparatus, and process in which the time and configuration requirements for the painting process are reduced, resulting in a homogeneous and sequential painting stage for the edges of the notebooks, as it does not depend on the arrangement of a required number of notebooks in a manual apparatus or on a specific viscosity of the paint or ink applied.

### BRIEF DESCRIPTION OF THE INVENTION

The present invention discloses a system, apparatus, and process for painting the edges corresponding to the edges of the pages of a notebook or notepad, which is fully integrated into a production process, where the final product is a notepad or notebook with its three edges colored.

The system for painting the edges of notebooks or notepads of the present invention has the ability to adapt to a linear process, particularly in the final stage of notebook manufacturing, wherein the final product is a notebook with its three edges colored as a feature for easy identification or recognition. In this sense, the system comprises a feeding module wherein the products to be painted, in this case the notebooks, are placed so that their edges can be painted; a first spraying module that guides each of the notebooks it receives from the feeding module through a transport path that compresses two ends corresponding to two edges of the notebook to be painted by spraying by at least one device arranged on each side of the transport path. The first spraying module applies the required ink by spraying it evenly to paint two of the three edges of each of the notebooks once it detects the passage of each of the notebooks that are conveyed through it.

Likewise, the system of the invention comprises a redirection module that changes the direction of transport of each of the notebooks once two of their edges have been painted, so that it adjusts the position of each of said notebooks to paint a third edge that has not been painted. A second spraying module guides each of the redirected notebooks along a transport path that compresses only one end of each notebook, specifically the end corresponding to the third edge to be painted by spraying by at least two devices arranged on the side of the transport path, where the second spraying module exerts pressure on the corresponding edge.

In one embodiment, the process for painting the edges of notebooks comprises the steps of feeding a notebook into a first transport path, guiding and applying pressure to two of the ends of the notebook through the transport path, applying ink by spraying to the pair of pressed edges of the notebook after activating and deactivating spray nozzles (spray devices) located on each side of the first path when the passage of the notebook is detected; orienting the notebook once two of its edges have been painted toward a second transport path; guide and apply pressure to the third edge of the notebook along the second transport path, apply spray ink to the third edge after activating and deactivating spray nozzles on the second path, and transport the notebook with all three edges painted to a final product reception area.

Thus, the present invention improves the efficiency and uniformity of painting the edges of a notebook. In addition, it allows for modifications to be made to the functional parameters of the system, which makes it possible to paint batches of notebooks of different thicknesses and to use ink within the viscosity parameter of 1-30, thus covering a wide range of colors.

### BRIEF DESCRIPTION OF THE FIGURES

FIG. 1. A preferred embodiment of the system for painting the edges of a notebook according to the present invention is shown.

FIG. 2. An upper side perspective view of a preferred embodiment of a feed assembly of the apparatus for painting the edges of notebooks according to the present invention is shown.

FIG. 3. A side view of a preferred embodiment of the spraying assembly of the apparatus for painting the edges of notebooks according to the present invention is shown.

FIG. 4. An upper side view of a preferred embodiment of the redirection assembly of the apparatus for painting the edges of notebooks according to the present invention is shown.

FIG. 5. An overhead perspective view of a preferred embodiment of the second spray assembly of the apparatus for painting the edges of notebooks according to the present invention is shown.

### DETAILED DESCRIPTION OF THE INVENTION

The detailed description presents the embodiments by way of illustration, including the best mode. While these embodiments are described in sufficient detail to enable those skilled in the art to practice the principles of the present disclosure, it will be understood that other embodiments may be implemented and that logical, mechanical, and/or electrical changes may be made without departing from the spirit and scope of the principles of the present disclosure. Therefore, the detailed description herein is presented for illustrative purposes only and is not intended to be limiting.

With the system, apparatus, and process according to the exemplary embodiment of the invention, the edges of a notebook are painted uniformly, which corresponds to a final stage in the production process of a final product, in this case, a notebook with colored edges.

For the sake of brevity, certain subcomponents of the individual components, as well as other aspects of the system, may not be described in detail in this document. It should be noted that many alternative or additional functional relationships, as well as physical couplings, may be present in a practical system, for example, in a control system involved in each of the stages of the process and system of the invention, such as in functional blocks which may be implemented by any number of appropriate components configured to perform specific functions.

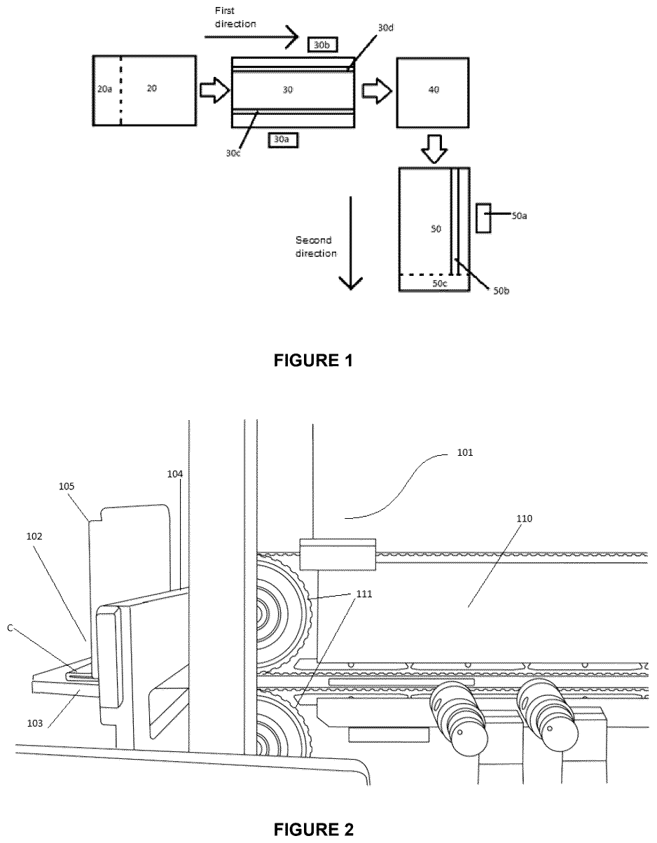

An embodiment according to FIG. 1 shows a mode of the system for painting the edges of notebooks or notepads (10) of the present invention, wherein a feed module (20) comprises a reception area (20a) wherein a plurality of notebooks are stacked so that their edges can be painted. The feeding module (20) is configured to channel each of the notebooks to be painted towards a spraying module (30). The spraying module comprises a pair of lateral pulling elements (30c, 30d) that propel each notebook in the direction of a first common transport path with a space reduction zone so that two of the edges of the notebook are subjected to compression to eliminate the free spaces between sheets, thus preventing the absorption of ink beyond the edge of the sheets.

Continuing with FIG. 1, the transport path of the spraying module also defines a painting zone with at least one painting device (30a, 30b) arranged on the side of each of the two lateral pulling elements (30c, 30d). Each painting device (30a, 30b) is configured to apply ink by spraying in a homogeneous manner and in synchrony to the corresponding edges of the notebook that are driven by the two lateral pulling elements of the spraying module (30) when it detects the passage of the notebook through the painting zone, and the painting devices (30a, 30b) are deactivated once the notebook crosses said zone.

Likewise, the system for painting the edges of notebooks (10) also comprises a redirection module (40) that comprises an electromechanical mechanism, but is not limited to this, configured to establish an adequate direction for applying ink to a third edge, which has not yet been painted, of each notebook coming from the spraying module (30). Thus, the redirection module (40) directs each of the notebooks to a second spraying module (50). The second spraying module (50) is similar to the spraying module (30), but differs in that it comprises only a lateral pulling element (50b) that guides the notebook along a second transport path through a space-reducing zone to subject the third edge of the notebook to pressure, and comprises a painting zone with at least one painting device (50a) arranged on its side.

At least one painting device (50a) of the second spraying module (50) is also configured to apply ink by spraying in a homogeneous manner and in synchrony to the third edge of the notebook that drives the lateral pulling element (50b) of the second spraying module (50) when it detects the passage of the notebook through the painting zone, and the painting device (50a) is deactivated once the notebook crosses the zone and is driven towards the exit (50c) of the second spraying module (50), thus obtaining the finished product or a notebook with its three edges colored.

In one aspect, the invention relates to a process for painting the edges of notebooks using the system shown in FIG. 1, which can be configured by means of a control module (not shown), which can be one of many that can be found in the state of the art, including PLCs, microcontrollers, relay arrays, electronic control circuits, etc. Where, in a preferred embodiment, the process comprises: a) receiving the notebooks to be painted in a reception area (20a) of the feed module (20); b) conveying each of the unpainted notebooks, by means of a feed module (20), to a spraying module (30); c) receiving and applying pressure to two of the edges of the notebook by means of a pair of lateral pulling elements (30c, 30d) of the spraying module (30); d) conveying the notebook with two of its edges pressed in a first transport path towards a painting zone; e) detecting the passage of the notebook through the painting area and activating the painting devices (30a, 30b) to apply ink by spraying evenly to the pressed edges of the notebook; f) modifying the position of the notebook, by means of a redirection module (40), which is guided towards a second spraying module (50); g) receiving the notebook to be painted and applying pressure to the missing edge of the notebook by means of a lateral pulling element (50b) of the second spraying module (50); h) guiding the notebook with the pressed edge along a second transport path towards a painting area; j) detecting the passage of the notebook through the painting zone, and activating the painting device (50a) to apply the ink by spraying it evenly onto said edge; and finally k) transporting the notebook with its three edges painted out of the second spraying module (50) to an exit zone (50c), thus obtaining the finished product.

In a second aspect, the invention relates to an apparatus for painting the edges of notebooks, according to FIG. 2, in a preferred embodiment of the invention, the device comprises a feed assembly (101) with a receiving area (102) capable of holding a stack of notebooks to be painted on a base platform (103), side walls (105), and a front wall (104) that confines the stack of notebooks on the side opposite their spines and a pair of side walls. The base platform (103) moves in a feed direction by means of a drive mechanism, thus the base platform (103) moves together with the bottom coloring book (C) in the stack of coloring books through a slot sized for its passage through the front wall (104) toward a pair of lateral pulling mechanisms (111) of a spraying assembly (110); so that only the notebook to be painted (C) at the bottom of the stack of notebooks is conveyed to the lateral pulling mechanisms (111). Thus, according to FIG. 2, the feed assembly (101) feeds the notebooks to be painted one by one at preset intervals in a control unit towards the spraying assembly (110) of the apparatus.

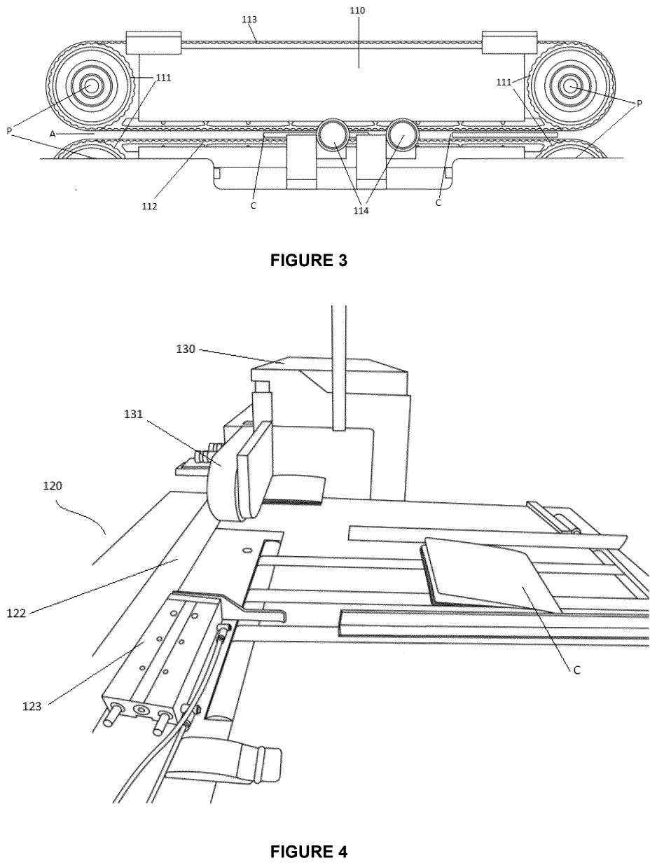

FIG. 3 shows a side view of the spraying assembly (110) of the apparatus of the invention, which comprises on each of its sides a lateral pulling mechanism (111) consisting of a lower conveyor belt (112) and an upper conveyor belt (113) driven by pulleys (P). The lower and upper conveyor belts define a transport path with a reduction zone (A). The lateral pulling mechanisms (111) of the spraying assembly (110) play a fundamental role, since the notebook experiences resistance to passage along the transport path, subjecting the notebook (C) to sufficient compression to eliminate the spaces between the pages of the notebook to be painted, in order to prevent the ink from being absorbed beyond the edge of its pages. A painting zone is defined along the transport path wherein a detector element detects the passage of the notebook through this zone to activate the operation of a pair of spray nozzles (114) located on the sides of each lateral pulling mechanism (111) and deactivated after a preset period of time has elapsed in the control unit. In this way, the pair of spray nozzles (114) applies ink evenly to the compressed edge of the notebook (c), which is conveyed along a first transport path at a constant speed preset in the control unit, so that the pair of spray nozzles (114) is deactivated once the notebook has crossed the painting zone.

As part of a technical advantage, in this first stage, two fundamental processes for the painting process are achieved: the compression of the notebook and the application of ink. This is because a configuration has been achieved where compression and ink application are performed while the notebook is in motion. It should be noted that, in the state of the art, the compression and painting operations are performed by independent mechanisms and not by a system configured to interact jointly.

In accordance with the embodiment of the apparatus for painting the edges of notebooks, the spray assembly (110) of FIG. 3 paints two edges of the notebook (C), the upper and lower edges, by means of an arrangement of two spray nozzles (114) located on the side of each lateral pulling mechanism (111), without limiting its configuration in terms of the number of nozzles used and the distance between them.

With reference to FIG. 4, which shows a preferred embodiment of the redirection module, once ink has been applied to the upper and lower edges of the notebook (C) during the trajectory of the spray assembly, the notebook exits the spray assembly and continues its trajectory towards a redirection assembly (120) that forms part of the apparatus of the invention. The redirection assembly (120) of the apparatus (110) comprises a displacement mechanism that guides the notebook with two of its edges painted (top and bottom) to a stop wall (122) that slows the displacement of the notebook (C); a detector element (not shown) detects when the edge opposite the spine of the notebook (the unpainted edge) contacts the stop wall (122), the control unit (not shown) activates a pushing mechanism (123) that moves the notebook toward a lateral pulling mechanism (131) of a second spraying assembly (130).

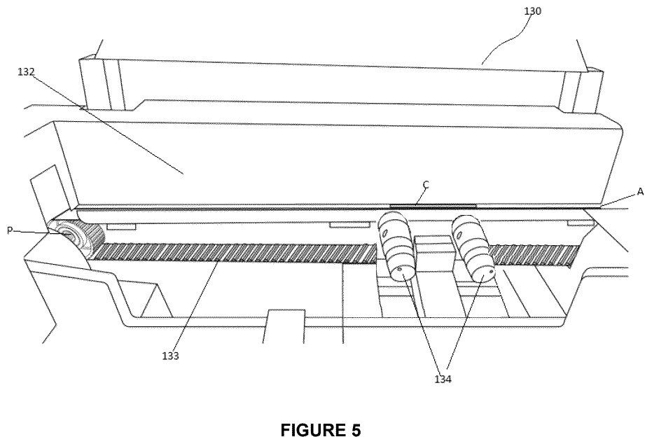

Based on FIGS. 3 and 5, the second spraying module (130) is similar to the spraying module (110) shown in FIG. 1, wherein the most significant difference is that the second spraying module (130) only comprises a lateral pulling mechanism (131). According to FIG. 5, the lateral pulling mechanism (131) comprises a lower conveyor belt (133) and an upper conveyor belt covered by a plate (132), both belts being driven by pulleys (P). The lower and upper conveyor belts maintain a transport path with a reduction zone (A).

The lateral pulling mechanism (131) of the second spraying assembly (130) subjects the third edge (unpainted) to sufficient compression to eliminate the spaces between the sheets of the notebook to be painted, preventing the ink from being absorbed beyond the edge of the sheets. Likewise, the transport path defines a painting zone where a detector element detects the passage of the notebook through this zone to activate, via the control unit, the operation of a pair of spray nozzles (134) located on one side of the pulling mechanism, and deactivates their operation after a preset period of time has elapsed in the control unit. In this way, the pair of spray nozzles (134) applies ink evenly to the third compressed edge of the notebook (c), and the pair of spray nozzles (114) stops applying ink once the notebook has crossed the painting zone.

With regard to the notebook detection function, this is performed by at least one sensor comprising optoelectronics, capacitive sensors, micro-switches, among others known in the prior art, which is positioned in the path of the notebook in the space reduction zone (A) and close to said pair of spray nozzles (134).

In one embodiment of the present disclosure, the pulling mechanisms are actuated by a control module (not shown) which, upon detecting the presence of notebooks in the reception area (20a), begins by activating at least one motor (not shown) that activates the upper (30c) and lower (30d) belts, wherein said motor can be any of those known in the prior art. In one embodiment of the present disclosure, the control module (not shown) sets the speed of the pulling mechanism according to various process parameters such as notebook size, ink viscosity, ink design to be applied, etc.

In a preferred embodiment of the present invention, the speed of the pulling mechanism adjusts the system so that upon receipt of the signal from said at least one sensor (not shown), an adjustment signal is processed for the activation and deactivation of the spray nozzles (30a, 30b, 50a), and wherein said process can be replicated to various spray nozzles encountered during the process.

In a preferred embodiment of the invention, the system modules correspond substantially to the apparatus assemblies.

Modifications to the structure of the apparatus for painting the edges of notebooks of the present invention or any of its elements described herein may be envisaged by those skilled in the art. Therefore, the scope and extent of the present disclosure should not be limited by any of the exemplary embodiments described above, but should be defined only in accordance with the following claims and the equivalents thereof. The foregoing description has been presented for purposes of illustration and description. It is not intended to be exhaustive or to limit the disclosure to the precise form described. Many modifications and variations may be made in light of the above teachings. Furthermore, it should be noted that any or all of the above-mentioned alternative implementations may be used in any desired combination to form additional hybrid implementations of the disclosure. The scope of the disclosure is defined by the appended claims herein.

### LIST OF ITEMS CORRESPONDING TO THE FIGURES

Feeding module (20)
Reception area (20a)
Spraying module (30)
First pair of nozzles on the first trajectory (30a)
Second pair of nozzles on the first trajectory (30a)
A first lateral pulling mechanism for the spraying module (30c)
A second lateral pulling mechanism for the spraying module (30d)
Redirection module (40)
Second spraying module (50)
Pair of nozzles for the second spraying module (50a)
Traction mechanism for the second spraying module (50b)
Exit zone (50c)
Feed assembly (101)
Receiving area (102)
Base platform (103)
Front wall (104)
Side walls (105)
Spray assembly (110)
Pair of lateral pulling mechanisms (111)
Lower conveyor belt (112)
Upper conveyor belt (113)
Spray nozzles of the spray module (114)
Pulleys (P)
Reduction zone (A)
Notebook (C)
Redirection assembly (120)
Stop wall (122)
Push mechanism (123)
Second spray module (130)
Side pulling mechanism of the second spray module (131)
Upper conveyor belt of the second spraying module (132)
Lower conveyor belt of the second spraying module (133)
Pair of nozzles of the second spraying module (134).

1. A system for painting the edges of notebooks, comprising:
a spraying module that guides each of the notebooks it receives from a feeding module through a transport path, the spraying module compressing two ends corresponding to two edges of the notebook to be painted by spraying by at least one device arranged on each side of the transport path;
a redirection module that changes the transport direction of each of the notebooks once two of their edges have been painted so that a third edge can be painted;
a second spraying module that guides each of the redirected notebooks into a second transport path that compresses the edge of each notebook that has not been painted so that it can be spray-painted by at least one device arranged on the side of the second transport path, and guides it to an exit area.

2. The system according to claim 1, wherein the feeding module comprises a notebook receiving zone and a base platform.

3. The system according to the preceding claims, wherein the spraying module comprises a pair of lateral pulling mechanisms and a pair of nozzles arranged on either side of the lateral pulling mechanisms.

4. The system according to the preceding claims, wherein the redirection module comprises a pushing mechanism.

5. The system according to the preceding claims, wherein the second spraying module comprises a pulling mechanism and a pair of nozzles arranged on one side of the pulling mechanism of the second spraying module.

6. An apparatus for painting notebook edges, comprising:
a feed assembly, comprising a notebook receiving area and a base platform, for receiving the notebooks and starting the process;
a spraying assembly, comprising a pair of lateral pulling mechanisms that exert pressure on two edges of the notebook, and a pair of nozzles arranged on each side of the lateral pulling mechanisms that apply ink to the two edges of the notebook under pressure;
a redirection assembly, comprising a pushing mechanism for changing the direction of the notebook; and
a second spraying assembly comprising a pulling mechanism that applies pressure to the third, unpainted edge, and a pair of nozzles arranged on one side of the pulling mechanism of the second spraying module for applying ink to the edge under pressure.

7. The apparatus according to claim 6, characterized in that the pulling mechanisms comprise an upper belt and a lower belt.

8. The apparatus according to preceding claims 6 to 7, characterized in that the upper and lower belts are driven by pulleys.

9. The apparatus according to preceding claims 6 to 8, characterized in that the sensors located in the spraying module, redirection module, and second spraying module may be any of optoelectronic, capacitive, and micro-switches.

10. A method for painting the edges of notebooks, comprising the steps of:
a) guiding each of the notebooks received from a feed module through a transport path;
b) compressing two ends corresponding to two edges of the notebook;
c) applying ink to the two compressed edges by spraying;
d) changing the direction of transport of each of the notebooks once two of their edges have been painted so that a third edge can be painted;
e) compressing the edge of each notebook that has not been painted;
f) applying ink to the compressed edge by spraying; and
g) conveying the notebook with all three edges painted to an exit area.

11. A notebook characterized in that its edges are painted using the method of claim 10.
